(19) United States
(12) Patent Application Publication
(10) Pub. No.: US 2007/0209250 A1
(43) Pub. Date: Sep. 13, 2007

(54) Image Viewer for Changing Image Display

(76) Inventors: Peter F. Lindemann, Aurora, CO (US); Angela D. Bowen, Aurora, CO (US); Joshua J. Jones, Aurora, CO (US)

Correspondence Address: KYLE W. ROST, 5490 AUTUMN CT., GREENWOOD VILLAGE, CO, 80111, US

(21) Appl. No.: 11/620,040

(22) Filed: Jan. 4, 2007

(51) Int. Cl. G09F 19/00

(52) U.S. Cl. 40/440

(57) ABSTRACT

A rotating changing image display carries an image group and decoder screen that displays frames of the image group in a sequence determined by direction of rotation. A sequence of frames shows subject matter with identifiable directional motion. In order to ensure the sequence of frames will be displayed in proper order in accordance with the identifiable direction of motion, the display is mounted to a directional rotator. The rotator is wind driven. Airfoil structures of the rotator are configurable to drive the rotator and the carried display in the identifiable direction of rotation.

### BACKGROUND OF THE INVENTION

1. Field of the Invention

The invention generally relates to card, picture, or sign exhibiting showing an animated subject. More specifically, the invention relates to a picture with a changing exhibitor. In another aspect, the invention relates to a display with special effects, wherein the display is suspended on a rotatable carrier that may be wind powered. Under rotation, the display induces the special effects, or animation, with respect to the eye of the viewer. In another respect, the display relates to printed matter and to a particular arrangement of interacting printed elements placed on opposite faces of a clear intermediate substrate. The invention is an animated display consisting of a plurality of inter-related images that are sequentially viewable with improved crispness in transitions between images, as compared to similar known displays. Further, the invention is an animated display that shows improved brightness over similar known displays. In another respect, the invention generally relates to optical systems and elements.

2. Description of Related Art Including Information Disclosed Under 37 CFR 1.97 and 1.98

The ability to produce displays suggesting motion is desirable because people are attracted to motion. Displays presenting the illusion of motion are used as tools for advertisement and amusement. A type of display that will be referred to herein as a changing image display, presents the illusion of motion by suitably disposing a group of images in a first plane. A masking grid is suitably arranged on a different, parallel plane to sequentially reveal each one of the individual images of the group while hiding the others from view. Conveniently, the image group and masking grid may be carried on one or more sheets of clear glass or plastic.

The masking grid is formed of blocking bars separated by viewing spaces. The blocking bars are sized and positioned to hide all but the one image of the image group. Viewing spaces between the blocking bars expose the image that is not hidden. The non-hidden image will be referred to as the dominant image. The choice of which image from the image group will be the dominant image varies with the viewing angle of the observer. The separation between the plane of the masking grid and the plane of the image group allows the observer view different dominant images as the viewing angle changes. The observer's viewing angle to the plane of the display can change, for example, as the display rotates or as the observer passes the display.

In a changing image display, each display image is subdivided into a like number of image strips. The image strips of the different display images are arranged in a series or array, in alternating sequence according to a preselected, repeating order. Thus, the first image strip of a first display image is disposed in first position, followed by the first image strip of the second display image, and so on, so that the first image strips of all display images are disposed in a series, in the preselected order. The second image strips of each display image are next disposed in the series according to the same preselected order, and so on. The first blocking bar of the masking grid is wide enough cover all of the first image strips except one. The second blocking bar is wide enough to cover all of the second image strips except one, and so on. The observer's viewing angle variably selects which image strips are displayed at one time. The displayed image strips will be of a single image, thus variably determining which single image is dominant at a given viewing angle. With continuously changing viewing angle between the masking grid and the sequential series of image strips, the different sets of image strips forming each display image sequentially become dominantly viewable.

The technology to achieve a changing image display was disclosed at least as early as 1906 in U.S. Pat. No. 829,492 to Spiegel. The relative sizing and spacing of the masking grid is variable according to the selected number of display images in the image group. Where the image group consists of three display images, blocking bars are separated by a viewing space equal to one-half the width of a blocking bar, thereby exposing one-third of the image strips while blocking two-thirds of the image strips. In addition, the image strips in this display device are abutted side-by-side. Therefore, geometry dictates that a blocking bar must be substantially the same width as the number of image strips it is to block, while a viewing space between blocking bars must be substantially the same width or pitch as one image strip. Spiegel further explains that the separation between the plane of the masking grid and the plane of the display images influences how large an image group can be combined in a single changing image display. Thus, the Spiegel patent provides guidance for constructing changing image displays of variable complexity.

Many other workers used and modified this basic technology. In particular, workers noted a phenomenon often referred to as ghosting. The transition from one dominant image to another may be less than clean and crisp. The observer may see fragments of neighboring image strips while viewing a dominantly displayed image. The fragments or ghosts may appear as multiple views of a moving appendage. As an example, if the animation shows a running animal wherein the illusion of motion is chiefly concentrated on the various positions of legs, the observer may see the simultaneous display of more than the usual four legs of the animal. Typically, even if the observer stands perfectly still with respect to the changing image display, ghosting will constitute a showing of an additional four legs of the animal at roughly one-half the image density of the dominant image.

Ghosting occurs when the observer simultaneously sees parts of image strips from multiple images. Considering the Spiegel arrangement, if the plane of the masking grid is directly against the plane of the display images, then a properly registered blocking bar can almost perfectly cover its width of image strips. However, space between these planes is required if the changing image display is to operate by changes in the viewing angle. With the addition of planar space between the plane of the masking grid and the plane of the display images, the coverage becomes less perfect due to perspective and due to variability of viewing angle. The observer sees edges of image strips neighboring the one dominantly revealed. The neighboring image strips are from different display images than the dominantly revealed display image, which accounts for ghosting. In the example of the running animal, the neighboring image strips show the animal's legs in alternate positions. Thus, it is evident that the Spiegel arrangement of abutting image strips can lead to ghosting.

A recent worker in the art has proposed a solution to ghosting. U.S. Pat. No. 5,782,026 to Capie proposes a changing image display formed of a masking grid on one side of a transparent spacer and modified image strips on the other side of the spacer. The modified image strips have side edges modified to serve as separators. The edge areas are described as separation bars that create a non-image area between the residual image portions of neighboring image strips. The separator areas are sized at ten percent of the width of an unmodified image strip. Thus, at each side edge of an image strip, five percent of the width of the individual image is converted into a separator.

When a pair of neighboring image strips is considered, the separator area between residual image portions is equal to ten percent of the width of an unmodified image strip. In order to accommodate the separator areas without laterally stretching or distorting the design image, the separator areas cover or eliminate corresponding parts of the design image. Thus, each image strip loses ten percent of the unmodified design image, taken at the sides of each image strip. As described, Capie's image strip can be considered to be five percent separator area at each side edge and ninety percent residual design image in the center.

Capie proposes additional sizing formulas for constructing a changing image display. The viewing space between blocking bars is equal to the width of an image strip, including the five percent of separation area at each edge. The blocking bars of the masking grid have a width equal to the number of image strips to be blocked. Thus, Capie generally follows Spiegel's spacing formula.

It can be appreciated that Capie dealt with the ghosting problem by adding a non-image area between areas bearing images. The physics of light and perspective may require that edges of image strips neighboring the dominant image strip will continue to become exposed, but Capie converts those areas from potentially ghosting image areas into non-image areas. Capie teaches that the non-image areas are colored black.

Other patents, of which U.S. Pat. Nos. 3,000,125 and 3,082,560, both to Elvestrom, are leading examples, teach that border regions, which are non-image areas, can be of any color including clear or transparent. The latter patent to Elvestrom also suggests that the border regions should be about one-sixth the width of an image strip the will come into view, but the observer's eye may dismiss it, or at least the black edge areas should bear little similarity to the design images. Thus, by substituting black areas for recognizable portions of an image, Capie proposes a display with distinct, separate, and non-ghosting design images.

Recent U.S. Pat. No. 6,286,873 to Seder proposes a changing image display that employs a masking grid and display images on opposite sides of a transparent spacer. The image strips are abutted; and masking grid has equal pitch to the image strips.

From the described art, it is evident that considerable effort has been directed to creating a changing image display that is capable of smoothly and distinctly shifting between images. The net result has been the creation of many types of flat panel displays in which the images can change under selected circumstances.

The previously mentioned U.S. Pat. No. 829,492 to Spiegel discloses a dynamic flat panel display that changes between images by mechanically sliding one sheet carrying blocking bars with respect to another sheet carrying image strips. Under motorized control, the dynamic action changes the image even when the observer remains stationary.

As mentioned above, Spiegel also discloses the static display system wherein the blocking bars and image strips are in fixed relative positions, such as if printed on opposite sides of a single clear sheet, or if two sheets respectively carrying the blocking bars and image strips are held in fixed relationship to one another. Such a static arrangement successfully changes images as the observer moves with respect to the display, such that the observer varies his viewing angle with respect to the blocking bars and image strips. In addition, a static display can be supported for rotary movement so that the static display changes the viewing angle of a stationary observer. U.S. Pat. No. 5,695,346 to Sekiguchi, et al. describes arrangements of hanging static displays with blocking bars on one side of a clear sheet and image strips on the opposite side. The above referenced patent to Seder likewise discloses hanging displays. Rotary motion can be imparted randomly, such as by wind, and this is a desirable source of movement when the changing image display is employed as an ornament or decorative accessory similar to a mobile.

Refinements in changing image displays have produced lifelike and smoothly shifting images often consisting of a large plurality of images. The subject matter of these images often relates to directional motion, such as to a human or animal running in a forward direction, or to an object moving in a forward direction. The forward direction, or any other chosen direction, is a product of viewing the large plurality of changing images in an appropriate sequence. In turn, the observer sees the appropriate sequence only if the changing images change in the correct direction. For example, if a changing image display is suspended on a string and allowed to rotate randomly, the display can rotate in either of two directions, which can be called clockwise or counterclockwise with respect to a vertical axis. In only one of these directions will the motion be proper, such as forward motion. With opposite rotation, the motion will appear to be in reverse, which might be comical but is generally undesirable. Due to the large plurality of images that form a modern changing image display, reverse motion can be highly evident.

It would be desirable to create an ornamental changing image display with a preferred direction of rotation establishing a preferred sequence of viewable image, coupled with a means for imparting preselected bias in direction of rotation so as to sequence the succession of displayed images in the preferred sequence. Particularly in an ornamental display, which may be hung or used in an environment similar to a wind chime or mobile, motorized rotators are inappropriate. Therefore, the invention contemplates the combination of a changing image display with a moving-air-powered directionally biased rotator, such that random breezes will tend to rotate the changing image display in the preferred direction.

Directional rotators are known in many forms, from windmills to pinwheels, but these have not been used to display a large plurality of images in a preferred order. Particularly, they have not been applied to solving the problem of displaying a series of related images in a preferred sequence to create the illusion of motion in a preferred or preselected direction, especially a forward direction. More particularly, they have not been applied to solving the problem of changing the viewing angle between a plane of image strips and a spaced apart plane of blocking bars in a changing image display having a preferred direction of rotation in order to display sensible motion.

To achieve the foregoing and other objects and in accordance with the purpose of the present invention, as embodied and broadly described herein, the method and apparatus of this invention may comprise the following.

### INCORPORATION BY REFERENCE

Air powered directional rotators that might be adapted to carry a changing image display are known in at least the following patents: U.S. Design Pat. No. 110,858 to Egerton; U.S. Pat. No. 3,747,263 to Grossbert; U.S. Design Pat. No. 472,183 to Flohe; U.S. Pat. No. 6,783,815 to Flohe; U.S. Pat. No. 7,007,354 to Flohe; U.S. Design Pat. No. 518,410 to Schobinger et al; U.S. Pat. No. 7,127,842 to Murthy; U.S. Design Pat. No. 528,463 to Schobinger et al; and U.S. Design Pat. No. 533,106 to Schobinger et al. These patents are hereby incorporated by reference.

The structures and methods of making changing image displays using blocking bars and image strips arranged in spaced apart planes, preferably separated by a clear substrate, are taught in at least the following patents: U.S. Pat. No. 829,492 to Spiegel; U.S. Pat. No. 3,000,125 to Elvestrom; U.S. Pat. No. 3,082,560 to Elvestrom; U.S. Pat. No. 5,695,346 to Sekiguchi, et al.; U.S. Pat. No. 5,782,026 to Capie; and U.S. Pat. No. 6,286,873 to Seder. These patents are hereby incorporated by reference.

### BRIEF SUMMARY OF THE INVENTION

Against the described background, it is therefore a general object of the invention to provide a changing image display that is rotated by an air-powered rotator that is biased in rotational direction. Further, the changing image display is formed of a large plurality of sequentially viewable images of related subject matter, such as images of a subject in motion wherein motion in one direction, i.e., forward motion, can be distinguished from motion in the opposite direction, i.e., backward motion. The presentation of subject matter differs according to the direction of rotation. Accordingly, the bias of the rotator establishes an order of image presentation. In a typical example, the order of image presentation will be biased to show forward motion of a subject, rather than backward motion.

According to the invention, an image viewer for a changing image display includes a changing image display formed of a clear substrate of predetermined thickness between opposite, first and second major faces. The display is rotatable about a central display axis. A first major face of the display carries a multi-frame integrated image group. A second and opposite major face of the display carries a decoder screen for the image group. The image group and decoder screen are mutually oriented on the substrate to display to an external reference point a sequence of individual frames of the multi-frame image group by rotation of the display about the central axis. A directional rotator includes an airfoil configurable to drive the directional rotator in a single direction of rotation about a central rotator axis. Carrying devices that are associated with the directional rotator carry the changing image display with the display axis approximately aligned with the rotator axis.

In another aspect or the image viewer, the directional rotator is formed of a series of concentric rings sized from a smallest ring to a largest ring, joined by a diametric spine. The smallest ring defines a central reception area of predetermined configuration for receiving the changing image display. The changing image display is peripherally configured to fit within the central reception area. An attaching device connects the changing image display to the smallest ring and maintains the changing image display in the central reception area.

In a further aspect of the image viewer, the directional rotator has opposite faces. At least some of the concentric rings define the airfoil, with rings on one side of the diametric spine defining a first airfoil cup open to a first face of the rotator. Rings on the opposite side of the diametric spine defining a second airfoil cup open to the opposite face of the rotator. The arrangement of the airfoil cups establishes a direction of airfoil rotation when wind is received in the cups.

As an aspect of the image viewer, rings forming the cups are disposed at different angles about the spine, such that the rings establish gaps in the cups for venting wind. The gaps decrease the efficiency of the airfoil so that it responds inefficiently to short wind gusts.

In the image viewer, the multi-frame integrated image group includes a plurality of at least three sequentially viewable frames showing a subject in a directionally identifiable sequence of motion. Rotation of the changing image display in a first rotational direction about the central display axis causes display of the at least three sequential frames in the directionally identifiable sequence. The airfoil is configured to rotate the directional rotator and the carried changing image display in the first rotational direction so as to display the at least three sequentially viewable frames in the proper direction for viewing the directionally identifiable sequence of motion in proper order.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is an isometric front view of a clear disc having image strips of a changing image display on the rear side thereof, viewable through the clear material of the disc.

FIG. 2 is an isometric front view of a clear disc similar to that of FIG. 1, having blocking bars of a changing image display on the front side thereof.

FIG. 3 is a schematic view of image strips on one side of a clear spacer and a decoder screen on the opposite side of the spacer, showing lines of sight perpendicular to the spacer and at an angle θ on either side of the perpendicular line of sight.

FIG. 4 is a front elevational view of a carrier suited to receive and carry a clear disc similar to those of FIGS. 1 and 2, wherein the carrier is formed of a plurality of rings joined to a central vertical spine, with the rings shown in a flat, undeployed configuration. In addition, this figure shows a spinner carrying the carrier from the top of the spine.

FIG. 5 is a fragmentary front elevational view of the first or inside ring of a carrier similar to that of FIG. 4, carrying a disc similar to those of FIGS. 1 and 2.

FIG. 6 is a top plan view of a carrier similar to that of FIG. 4, in deployed configuration wherein rings are fanned about a central vertical spine into separate planes in order of size with the inside, first, or smallest ring fanned the furthest behind the outside, last, or largest ring.

### DETAILED DESCRIPTION OF THE INVENTION

The invention is an image viewer for a changing image display. In particular, the invention is an image viewer for a changing image display that provides a large plurality of related images that, when viewed in appropriate sequence, provide a looped image clip of a subject moving in a preselected direction. Stated in another way, the invention is a viewer that aids a changing image display to consistently rotate in a single rotational direction about a centerline axis. The changing image display is designed to display a large plurality of images in a sequence suggesting motion as the display is rotated on a central vertical axis. References to a large plurality of images refer to three or more images, as explained below.

When motion is shown by sequential display of a large plurality of sequentially related images viewed on a rotating display, the motion can assume a practical bias in order of display. The images should be viewed in one order, such as with either clockwise or counterclockwise rotation of the disc. If only two images are used, the subject matter might be viewed in either odirection with the same result. For example, if the subject matter is a man walking, the two images of the display might show one foot in either an extended position or a non-extended position. Regardless of the order in which the two images are viewed, image one image shows one position of the feet, and image two a second position of the feet. There is no bias in how the two images are viewed, since the images follow the same sequence of one, two, one, two, etc. However, when three or more images are used, then the order of viewing differs according to the direction of disc rotation, showing the images in the order one, two, three, versus three, two, one.

Often motion is distinctly identifiable as taking place in one direction versus the opposite direction. For example, even a person walking both moves his feet and also tilts his body. An observer of even a two-image sequence of a person walking may determine whether the person is walking forward or backward by the subtle tilt of the body. In other cases, the direction of motion is extremely evident, such as by the leg motions of a four-legged animal taking one stride. As an example, a horse can gallop in a forward direction but can back up only in a limited way that does not resemble a gallop. A galloping horse's legs assume characteristic shapes that are far different from the leg shapes of a horse backing up. Similarly, other four-legged animals travel forward with substantially different motions than when they travel backward.

Three of more sequential images of a galloping horse produce a bias in the order in which they should be viewed. This may be referred to as a realistically correct or forward bias, as horses cannot gallop in reverse. Other animals, such as birds and fish, have almost no ability respectively to fly and swim in reverse. These examples demonstrate that a series of images showing a moving person or animal typically can be identified as having a correct or preferred order of viewing or a bias for viewing to conform to knowledge or reality.

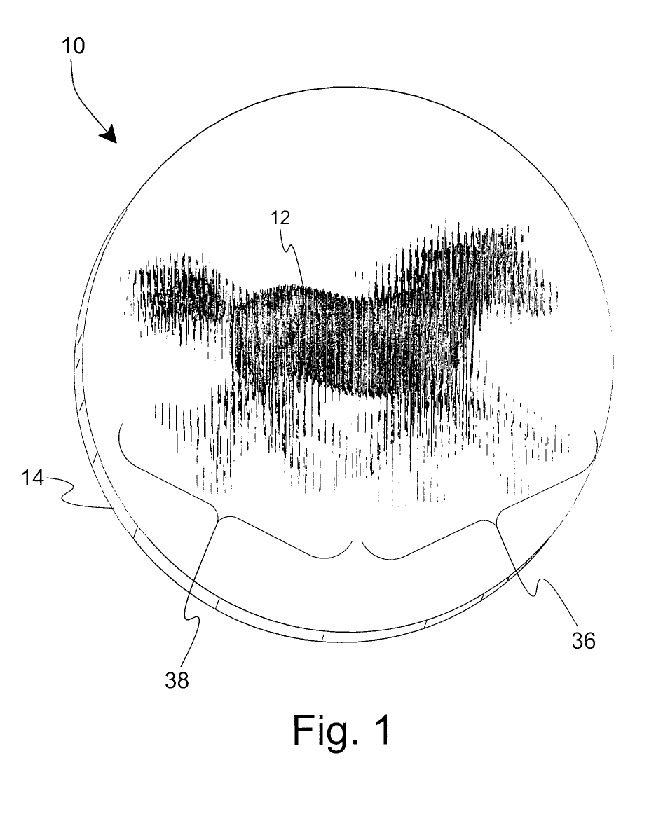

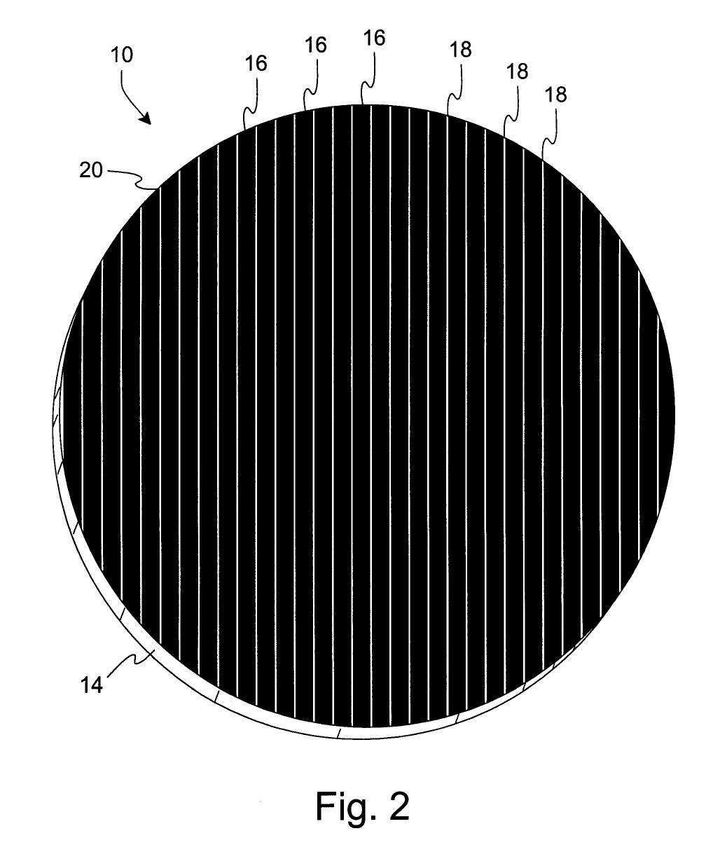

A changing image display 10 can be constructed by known techniques, as variously explained in certain of the patents incorporated by reference. In brief, FIGS. 1 and 2 show components of a preferred display. The components of a changing image display 10 include a multi-frame integrated image group 12 arranged for viewing while a disc 14 is rotating on a central axis, which may be referred to as a display axis. The image group 12 is displayed as a center animation. Thus, the changing image display 10 presents an animation consisting of a large plurality of related images, each of which may be called a frame, that are viewed in sequence to create the illusion of motion.

Most practically, the central display axis can be considered to be a vertical oriented from top to bottom of the view in FIGS. 1 and 2. The central axis need not be precisely vertical, and, in fact, the central axis can be disposed at any angle. The term, vertical, implies a relationship collinear with the force of gravity. A vertical axis is preferred because the display can be hung from a point collinear with a vertical axis, and if the center of mass lies on the axis, gravity will maintain the display approximately in vertical orientation.

In FIG. 1, a representative image group 12 is formed of image strips running parallel to the central axis and arranged in an array. A clear substrate such as disc 14 of glass or plastic carries the image group 12 on one major face. The term “clear” means visually transparent such that indicia printed or carried on one side of the substrate can be viewed from the other side. In the specific example of FIG. 1, the image group 12 consists of six images or frames of a horse on disc 14. Each image or frame is divided into image strips, and the image strips are interlaced or integrated in a known manner. According to the presentation of FIG. 1, the image group 12 can be considered to be printed or otherwise carried on the backside of the disc 14 and to be visible for viewing through the front of the disc 14.

FIG. 2 shows an array of spaced, elongated blocking bars 16 printed or otherwise carried on the opposite or front major face of disc 14. Together, the blocking bars 16 and view spaces 18 define a decoder screen 20. The function of the decoder screen 20 is to reveal, one by one, a sequence of individual images or frames that, together, comprise the image group 12. The decoder screen is formed of solid or opaque blocking bars 16. The blocking bars 16 can be considered to extend vertically or parallel to the central axis of the image group. The blocking bars extend between the end edges of the clear member 14. Clear bars or viewing spaces 18 separate juxtaposed blocking bars. The width of each blocking bar 16 along a horizontal axis is equal to W(bar) and the width of a viewing space 18 between each pair of juxtaposed bars 16 is equal to W(viewspace).

More accurately, the blocking bars 16 are separated from one another along an axis extending perpendicular to the elongated dimension of the blocking bars 16. If the blocking bars 16 extend vertically, then they are spaced on a horizontal axis. For convenience of explanation, vertical and horizontal positioning is mentioned as an example of preferred or ideal orientation. However, such references are specific examples of the more general situation where axes are perpendicular to one another regardless of orientation to gravity. The mentioned placements with respect to vertical or horizontal axes are desirable but not critical. However, for best performance of the changing image display, the blocking bars 16 and viewing space bars 18 on the front plane of disc 14 and image strips within image group 12 on the back plane of disc 14 should be mutually parallel. Parallel placements, as well as a reasonable degree of nonparallel placements, allow the blocking bars to sequentially show individual frames of the image group to an external reference point as the clear substrate rotates on a central display axis that likewise is approximately parallel to the blocking bars and image strips.

The image group 12 is produced on a digital computer. Initially, the several images that will be combined to form the image group 12 are superimposed on one another on the computer screen. The decoder screen 20 is superimposed over images. In addition, the decoder screen can be electronically moved to a succession of slightly different horizontal positions on the computer screen. These discrete positions are identified along a horizontal axis. From one position to the next, the decoder screen moves by a distance Δ(bar). The number of such positions is identified by the variable, N. Each of the N positions can be identified as a position, P. Thus, each position P is given a unique identifier such as P(1), P(2) . . . P(N). In a first position, P(1), the decoder screen 20 is centered over the image group 12 on the monitor screen. At position P(2), the decoder screen is shifted to a location at spacing Δ(bar) to the right of position P(1). Δ(bar) has a value of Δ(bar)=[W(viewspace)+W(bar)]/N. Position P(1) is equivalent to position P(N+1) and reveals the same frame from the image group.

In general, an image group 12 is made of a series of N frames, where each frame in the series has content similar to a successive frame of a movie film clip. The N frames are centered on top of each other on the monitor of the digital computer. Each frame is associated with a position, P, of the decoder screen 20. For example, when the decoder screen 20 is in position P(1), the associated frame one is edited by removing the portions of frame one that are covered by any blocking bar 16 of the decoder screen 20. The images of frame two through N are similarly edited when the decoder screen is shifted to respective positions P(2) through P(N).

For instance, a first image of the horse at the beginning of its stride will be referred to as frame one, and a second image of the horse slightly advanced in stride is frame two, and further images show successive advances of stride, through frame N. The portions of frame one that are covered up by a blocking bar 16 with the decoder screen 20 in position P(1) are removed, leavings only the portions of frame one that are visible between the blocking bars 16 of the decoder screen 20 in position P(1). The result is a series of image strips from frame one, arrayed with horizontal spacing, each image strip having a width of W(frame).

The editing process is repeated by shifting the decoder screen to the right to position P(2), associated with frame two, and the covered portions of frame two are removed. The process is repeated through positions P(N) associated with frame N. At the conclusion, viewed from left to right, each successive image strip one through N is a portion the next frame one through N of the movie clip. As a general rule, the Nth image strip is a portion of frame N, and W(viewspace)=W(frame). The space between the image strips of the image group 12 is equal to W(framespace), where W(framespace)=Δ(bar)−W(frame). A space should result between each image strip and its neighbor. If Δ(bar)=W(frame), the space between the image strips is lost, which is undesirable.

When the image group 12 and decoder screen 20 are superimposed, the decoder screen 20 reveals the frame of the image group 12 that corresponds with the position P(1)-P(N) of the decoder screen 20. The blocking bars 16 of the decoder screen 20 preferably are black; and the image strips of the image group 12 may be formed of black portions, as well, although color can be used. Where this black coloration of the image strips is used, the decoder screen fools the observer's eye and appears to fill in the missing portions of each frame of the image group 12. If the decoder screen 20 is moved smoothly to the right, it will reveal the images forming the image group 12 in succession and will appear to be playing the movie clip of N frames to an observer at an external reference point.

There are two purposes for having a space of width W(framespace) between the image strips of the image group 12. The first purpose is to reduce the amount of ghosting that is evident to the observer. Ghosting occurs when the decoder screen 20 is between two positions, and portions of two frames are visible at the same time. The ratio R(frame)=W(frame)/W(framespace) is a balance between too much ghosting and very little clarity. As this ratio increases, W(framespace) decreases, and the ghosting becomes worse. On the other hand, as the ratio decreases, W(frame) decreases, and therefore W(viewspace) decreases. If W(viewspace) becomes to small, the result will be poor visibility thorough the decoder screen 20. A ratio of approximately R(frame)=3 produces an acceptable balance between ghosting and loss of visibility. The second purpose of the spaces between juxtaposed image strips is to increase overall light transmission through the image group 12. Testing reveals that the amount of light transmission determines the quality and visibility of the finished product. While adding opaque spaces between image strips of the image group 12 can eliminate ghosting, the opaque spaces block a great amount of light and decreases the overall visibility of the display.

The overall scale of the image group 12 in the changing image display 10 is important. The scale determines how many image strips will be present and how wide each image strip will be. If the scale is large, there will be too few image strips, and the image strips will be too wide. The observer will see a poor quality image. However, if the scale is too small, detail is lost when the image strips are printed on the disc 14. For example, smaller elements such as the space between image strips can be lost. W(framespace) typically is the narrowest element of a design and should be used as the reference element to establish a scale where W(framespace) is not lost. A desirable scale would be approximately W(framespace)= 1/300 inch.

The following formulas establish the preferred design in terms of N, R(frame) and W(framespace):

W(frame)=[R(frame)][W(framespace)]

W(viewspace)=[R(frame)][W(framespace)]

W(bar)=[N−1][W(framespace)][R(frame)]+[N][W(framespace)]

Δ(bar)=[R(frame)+1][W(framespace)]

Changing image displays 10 have sometimes suffered ghosting or flashing due to transitions between images or frames. Testing shows that the magnitude of R(frame) has a lower limit of 1, that when approached, causes negative effects for observing the looping movie clip. If R(frame)=1, the space between the image strips would be the same size as an image strip, itself. The space between images strips likewise would be the same size as the viewing spaces 18 between the blocking bars 16 on the decoder screen 20. That is, W(framespace)=W(frame)=W(viewspace). These equalities will cause instances during transition between frames when no portion of any frame is visible. The result of such an occurrence is that the subject disappears and reappears with an accompanying flash of light. As disclosed above, if R(frame) increases, the amount of ghosting increases. Therefore, the magnitude of R(frame) is a balance between ghosting and flashing. Testing has determined that R(frame)=4 demonstrates acceptable balance between ghosting and flashing. Values of R(frame) in the range from 3 to 4 provide a good balance of ghosting, flashing, and loss of visibility through the decoder screen.

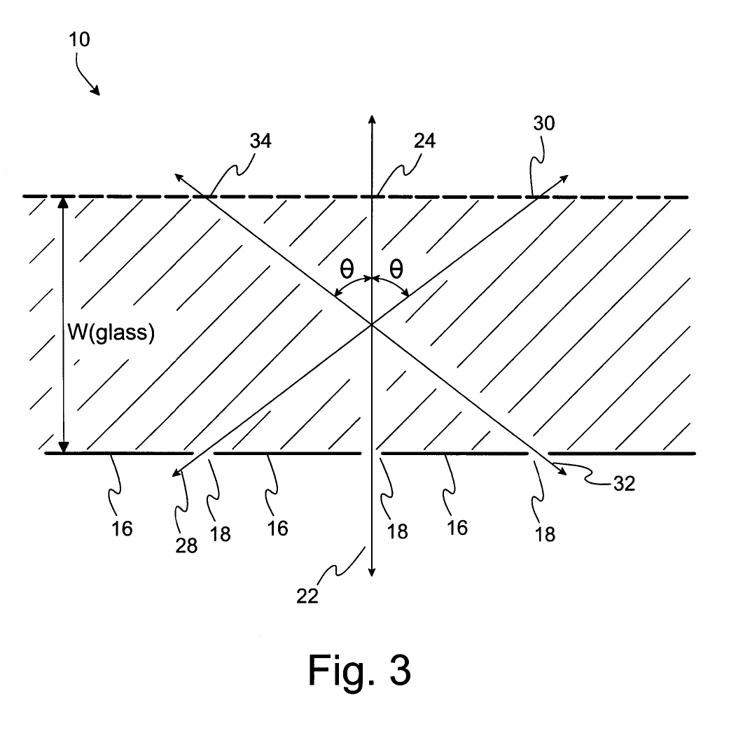

As suggested in the schematic view of FIG. 3, the changing image display 10 is formed by placing the decoder screen 20 and image group 12 on opposite sides of a clear member such as disc 14 of FIGS. 1 and 2. The disc 14 has a thickness W(glass), which is preferred to be approximately ⅛ inch. Due to the thickness of disc 14, the image group 12 is separated from the blocking bars 16 and viewing spaces 18. An observer at an external reference point sees different frames of image group 12 according to the angle of his line of sight. In FIG. 3, the perpendicular line of sight 22 allows viewing through a viewing space 18 to see an image strip 24. At a line of sight 26 at an angle θ to the left of line 22, the observer follows line of sight 28 to see image strip 30. At a viewing angle θ to the right of line 22, the observer follows line of sight 32 to see image strip 34. Thus, as the external reference point of the observer and the disc change in relative viewing angle over an angle of 2θ, the observer sees the sequence of image strips between image strips 30 and 34.

In FIG. 3, the viewed sequence includes twelve image strips. If N=6, the observer has seen two sequences of the movie clip over the angle 2θ. One technique for changing the line of sight over an angle θ is to spin disc 14 about its vertical center axis. The spinning will perform a function similar to sliding the decoder screen 20 through positions P(1)-P(N) in front of the image group 12 on a computer screen. The result is the display of changing images that simulates a continuously looping movie clip.

In FIG. 1, the effect of the changing image is best illustrated by the representations of the horse's legs, with front legs shown over area 36 and rear legs shown over area 38. Very few image strips represent each leg image because the legs are in relatively rapid motion. At the hoof end, possibly only one frame shows each hoof position. If N=6, then each leg is represented in six separate positions. In contrast, the horse's torso has less distinct movement and likely is represented within the same general area in every frame, which is evident from the dark and almost complete fill of the torso area. However, the image strips of the torso are separated by frame spaces of width W(framespace), such that the torso is not solid black.

The changing image display 10 is capable of showing an animated picture of three or more images or frames that are best viewed in a specified order, produced to rotating the display in a preselected direction of rotation. Displays 10 that are suspended for free motion may twirl or otherwise react to air currents in a nonspecific way. The display relies upon a clear substrate 14 to perform the essential function of spacing the blocking bars 16 from the image group 12. Clear substrates often have been glass or hard plastic materials that are not readily formed into airfoils. Thus, little has been done to ensure that the animated image will be viewed in conformity with a preferred viewing order, which can be described as forward viewing rather than backwards viewing. In fact, little has been done to cause such a substrate to rotate at all, other than suspending the substrate from a single line where rotation in one direction or the other is at least possible.

A changing image display presents its animated image at a rate proportional to speed of rotation, among other factors. A constant rate of rotation is desirable, and a modest rate of rotation is similarly desirable. A modest rate of rotation is on the order of one-half to three rotations per second. Because wind speed cannot be controlled, when wind is the energy source driving rotation via an airfoil, it is difficult to ensure that the rotation rate will be constant and moderate.

Certain characteristics of the airfoil are helpful in maintaining rotation at a constant and moderate rate. One such characteristic is to use a high mass airfoil to attenuate response to fluctuation in wind speed. Thus, a metal airfoil, especially a steel airfoil is a desirable choice. Another characteristic is to use an open airfoil or perforated airfoil so that response to changing wind speed is inefficient.

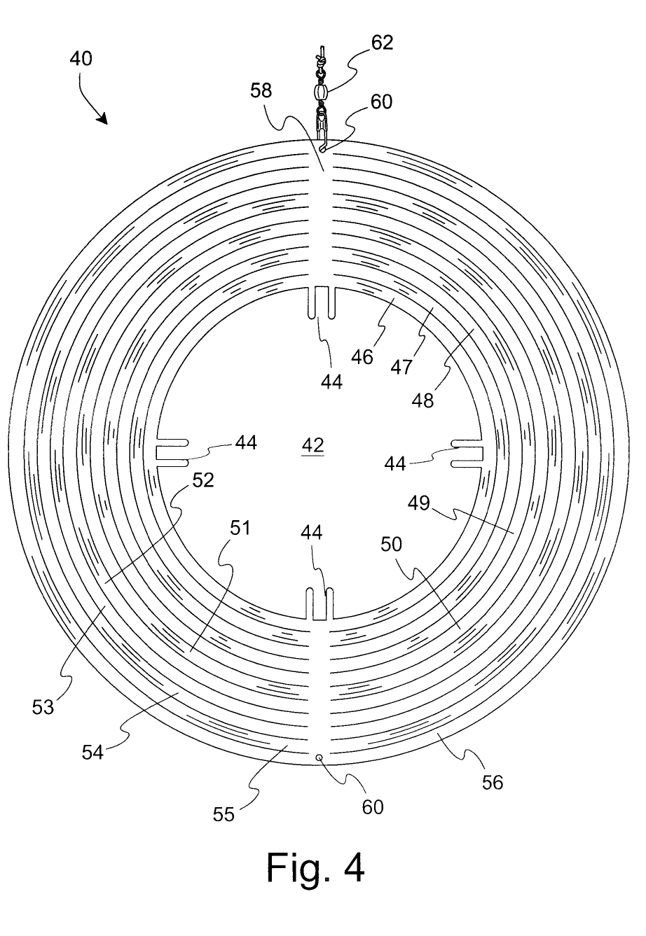

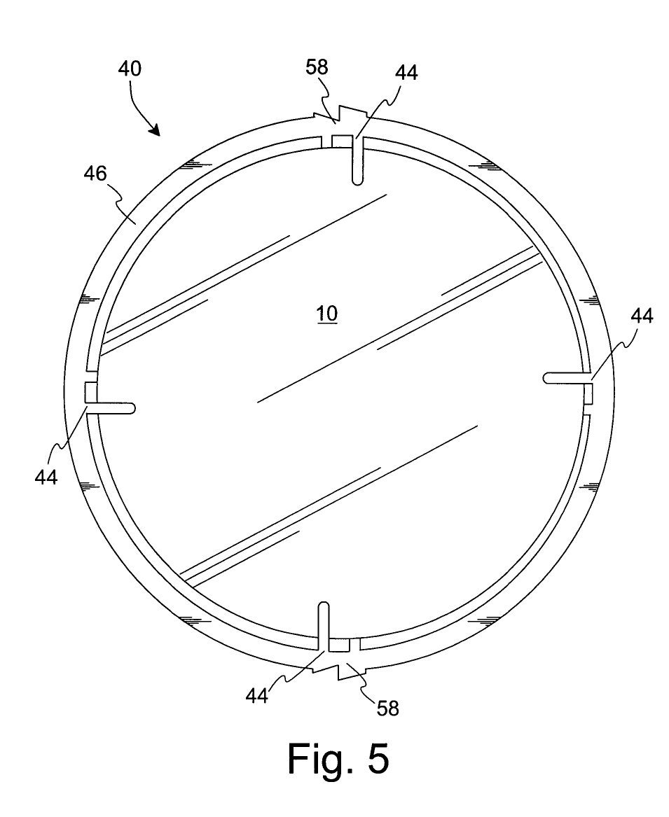

FIGS. 4 and 5 show a highly suitable directional rotator 40 that is powered by wind. As such, rotator 40 has features of an airfoil and conforms to the above-identified desirable characteristics. This general type of airfoil is described in various patents that have been incorporated by reference. An airfoil of this type can be modified to receive and hold a changing image display 10 to define a new image viewer.

The typical construction of the directional airfoil 40 begins with a sheet of steel shaped as a disc or flat annular shape. The center of the portion is removed, if necessary, to create an empty reception area 42 that is suitably sized to receive a changing image display 10. At the periphery of the central reception area 42, the airfoil includes attachment means such as finger pairs 44 for attaching the changing image display 10 to the airfoil. The attachment means 44 are in sufficient number and position to secure the display 10 such that it will rotate with the airfoil and cannot rotate without the airfoil. This, the rotational speed of the display 10 will be controlled by the speed of airfoil rotation.

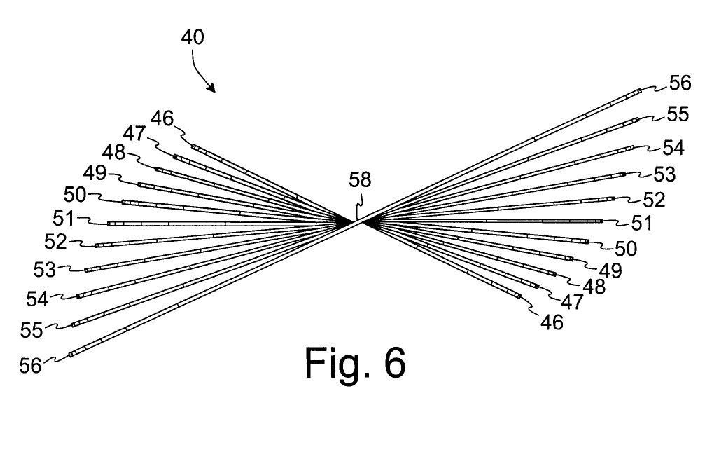

The airfoil 40 is formed of a series of nested concentric rings 46-56 that differ in size from a smallest, inner ring 46 to a largest, outer ring 56. Eleven rings are illustrated, but other numbers of rings can be selected. The rings are cut from the metal sheet, leaving a diametric spine 58 to bind them together. The right and left side cut portions of the rings on either side of the spine in FIGS. 4 and 6 may be referred to as semi-rings. The diametric spine 58 extends from the smallest ring 46 to the circumferential edge of the airfoil at largest ring 56 to interconnect each half-ring to its opposite half. The spine 48 also interconnects the various rings 46 to all of the other rings. The spine forms a suspension point such as a hanging hole 60 near the periphery of the disc at one or both ends of the spine 58. Thus, an axis of rotation lies along the spine 58 when the airfoil is suspended from a hanging hole 60. The axis of rotation typically will be a vertical axis when suspended from a hanging hole 60 and may be referred to as a rotator axis. The display 10 can be mounted to the airfoil with the display axis approximately aligned with the rotator axis. To enable durable rotation, the airfoil 40 is hung from a fishing line spinner 62 at one of the hanging holes 60.

FIG. 5 shows a detail of the preferred mounting of the display 10 to the airfoil 40. The innermost ring 46 carries the finger pairs 44. One finger of each pair 44 lies over the front face of the display 10, while the other finger of the pair lies over the back face of the display 10. Four pairs of fingers 44 are equally spaced around the periphery of the center reception area 42 to secure the display 10 with quadrant spacing. The fingers 44 are bendable, which enables a finger of each pair to be bent as necessary to secure the display 10 to the airfoil 40.

The airfoil can be configured to turn almost exclusively in only one direction of rotation in response to wind. From the perspective of the front face of the disc 40 as shown in FIG. 3, suitably deforming or displacing the sets of semi-rings preselects a direction of rotation. FIG. 6 shows an example of displaced semi-rings forming opposite cup-shaped recesses or concave pocket shapes for catching wind and driving the rotator in the preselected direction of rotation. The opposite cups are open to opposite faces of the rotator, such that one of the cups is open to the wind on each face of the rotator. In the view of FIG. 4 showing a front face of the rotator, the left semi-rings form a recessed cup. The right semi-rings form a negative cup shape on the front face, producing a convex surface extending from the front face of the airfoil. Viewed from the back face of the airfoil, the pattern is reversed.

The resulting arrangement is best shown in FIG. 6. The left side semi-rings are bent such that the smallest half-ring 46 is to the rear of a left side cup. Successively larger semi-rings 47-55 are increasingly closer to the largest half-ring 56 at the front of the left side cup. The right side semi-rings are bent oppositely such that smallest half-ring 46 is to the front of the right side foil, and the largest half-ring 56 is at the back of the foil. From the perspective of the rear face of airfoil 40 in the view of FIG. 4, the arrangement of convex and concave surfaces is reversed.

Wind striking the airfoil 40 shaped according to FIG. 6 will apply a greater driving force at the inside of a concave cup, while wind will be partially deflected around the opposite convex surface. As a result, the airfoil of FIG. 6 will be driven preferentially in clockwise direction. A reverse deformation of the semi-rings, or hanging the airfoil upside down from the opposite hanging hole 60, would produce preferential motion in counterclockwise direction. Between each pair of the deformed semi-rings forming each cup structure, the semi-rings leave a considerable gap. Wind can escape the cup structures through such gaps, causing the airfoil to be inefficient. Wind gusts or other changes in wind speed will produce reduced changes in speed of rotation due to the gaps.

The airfoil 40 is used to harness wind and drive the center animation. It is a high mass airfoil due to the metal construction, cut from a piece of sheet steel and bent into a shape that forms opposite facing cup-like sides. Each strip is a 2-D shape. Each strip's inner edge is formed from the same cut as the outer edge of the next smaller strip, where present. Exceptions are the outer-most strip 56, which has an outer edge that does not correspond with another strip, and the innermost ring 46, which has an inner edge that does not correspond with another strip.

The inner edge of the innermost ring 46 must leave a hole 42 large enough for the center animation display 10 to be mounted inside. Each strip's cut is broken near a center vertical spine 58, leaving a spine portion of approximately the width of each strip between halves of each strip. The spine 58 allows the bending of each half-ring about the central vertical axis or rotator axis to form the oppositely disposed cup shapes.

In forming the cup shapes, each successive strip should be bent several degrees past its neighbor. The overall resulting shape, as viewed in FIG. 6, should have the inner strip less than 90° from the outer strip. Due to the flexible nature of the sheet metal, the angle of the strips can be modified by hand at any time to alter or refine the speed of rotation. The strips of the airfoil 40 add a visual enhancement to the animation produced by display 10. As each strip passes a light-reflecting angle, the observer will see a radiating light effect, from the center strip outward.

The described image viewer for a changing image display provides both functional and ornamental improvements in the display of animated subjects. By combining a changing image display 10 with a directional rotator 40, the changing image display is rotated in a preferred direction of rotation, thereby establishing a preferred sequence of displaying viewable images of the display 10. The rotator 40 is a high mass type of airfoil and is complimentary to a changing image display with a large plurality of images defining the animation, especially where the animation shows directional motion. The rings of the airfoil are configurable to form rotator cups with substantial openings to vent air pressure, such that the airfoil rotates in response to average wind speeds with reduced tendency to respond to gusts or other short-term change in wind velocity. Accordingly, the speed of rotation tends to be well suited for driving a changing image display 10 at a suitable rate.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. An image viewer for a changing image display, comprising:
a changing image display formed of a clear substrate of predetermined thickness between opposite, first and second major faces, rotatable about a central display axis, carrying on said first major face a multi-frame integrated image group and carrying on said second major face a decoder screen, wherein the image group and decoder screen are mutually oriented on the substrate to display to an external reference point a sequence of individual frames of said multi-frame image group by rotation about said central axis;
a directional rotator including an airfoil configurable for rotating the directional rotator in a single direction of rotation about a central rotator axis;
means associated with said directional rotator for carrying said changing image display with said display axis approximately aligned with said rotator axis.

2. The image viewer of claim 1, wherein:
said directional rotator is formed of a series of concentric rings sized from a smallest ring to a largest ring, joined by a diametric spine;
said smallest ring defines a central reception area of predetermined configuration for receiving said changing image display;
the changing image display is peripherally configured to fit within said central reception area; and
further comprising attaching means for connecting the changing image display to the smallest ring and maintaining the changing image display in the central reception area.

3. The image viewer of claim 2, wherein:
said directional rotator has opposite faces;
at least some of said concentric rings define said airfoil, with rings on one side of said diametric spine defining a first airfoil cup open to a first face of the rotator, and rings on the opposite side of the diametric spine defining a second airfoil cup open to an opposite face of the rotator, whereby the cups establish a direction of airfoil rotation when wind is received in said cups.

4. The image viewer of claim 3, wherein said rings forming said cups are disposed at different angles about said spine, such that the rings establish gaps in the cups for venting wind, whereby the airfoil responds inefficiently to short wind gusts.

5. The image viewer of claim 1, wherein:
said multi-frame integrated image group includes a plurality of at least three sequentially viewable frames showing a subject in a directionally identifiable sequence of motion;
rotation of said changing image display in a first rotational direction about said central display axis causes display of said at least three sequential frames in said directionally identifiable sequence;
said airfoil is configured to rotate said directional rotator and carried changing image display in said first rotational direction so as to display the at least three sequentially viewable frames in the proper direction for viewing the directionally identifiable sequence of motion.
